(19) United States
(12) Patent Application Publication
(10) Pub. No.: US 2008/0288868 A1
(43) Pub. Date: Nov. 20, 2008

(54) MULTIMEDIA PROJECT MANAGER, PLAYER, AND RELATED METHODS

(76) Inventors: Tim Lakey, Crossville, IN (US); Scott Yates, Sedona, AZ (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/123,362

(22) Filed: May 19, 2008

Related U.S. Application Data
(60) Provisional application No. 60/939,031, filed on May 18, 2007.

(51) Int. Cl. G06F 3/00

(52) U.S. Cl. 715/716

(57) ABSTRACT

A novel enhanced multimedia player is disclosed that allows users to view multimedia presentations in a non-linear manner. Moreover, the systems and methods of the present disclosure provide an easy mechanism whereby smaller companies can have tailored multimedia presentations where those responsible for implementing the presentations are not experts in the preparation of multimedia presentations. Finally, changes in the organizational structure of multimedia presentations are easily accomplished on a modular basis.

### RELATED APPLICATIONS

This application claims the Paris Convention Priority of and hereby incorporates by reference Provisional Patent Application Ser. No. 60/939,031 filed on 18 May 2007 and entitled “Multimedia Project Manager, Player, and Related Methods.”

### BACKGROUND

The present disclosure relates to devices, systems, and methods for non-linearly displaying multimedia content.

### SUMMARY

A novel enhanced multimedia player is disclosed that allows users to view multimedia presentations in a non-linear manner. Moreover, the systems and methods of the present disclosure provide an easy mechanism whereby smaller companies can have tailored multimedia presentations where those responsible for implementing the presentations are not experts in the preparation of multimedia presentations. Finally, changes in the organizational structure of multimedia presentations are easily accomplished on a modular basis.

According to a feature of the present disclosure, a system is disclosed comprising at least one player having a multimedia presentation, at least one clip set associated with the multimedia presentation, and at least one multimedia clip associated with each clip set. A viewer may experience the multimedia clips in a non-default ordering.

According to a feature of the present disclosure, a method is disclosed comprising providing a multimedia presentation backend, wherein a user can upload and organize a plurality of clips into clips sets and players, wherein each clip may have associated with it hyperlinks, text, images, or other audiovisual supplemental media associated with the clip; and providing a player that (1) provides an interface for a viewer to select a desired player comprising at least one clip set effecting the display of the clips associated with the at least one clip set in a default order, (2) allows the viewer to select desired clips to be experienced from those displayed in an order different from the default order; and (3) displays at least one of the hyperlinks, text, images, or other audiovisual supplemental media associated with the clip.

According to a feature of the present disclosure, a machine readable medium having instructions stored thereon for performing the steps of providing a multimedia presentation backend, wherein a user can upload and organize a plurality of clips into clips sets and players and providing a player that (1) provides an interface for a viewer to select a desired player comprising at least one clip set effecting the display of the clips associated with the at least one clip set in a default order, (2) allows the viewer to select desired clips to be experienced from those displayed in an order different from the default order, and (3) displays at least one of the hyperlinks, text, images, or other audiovisual supplemental media associated with the clip is disclosed. Each clip may have associated with it hyperlinks, text, images, or other audiovisual supplemental media associated with the clip;

### DRAWINGS

The above-mentioned features and objects of the present disclosure will become more apparent with reference to the following description taken in conjunction with the accompanying drawings wherein like reference numerals denote like elements and in which:

FIG. 1 is a block diagram of an embodiment of the interrelationship of the various components of the multimedia player and management module;

FIG. 2A is a illustration of an embodiment of a multimedia player;

FIG. 2B is a illustration of an embodiment of a multimedia player;

FIG. 3A is a illustration of an embodiment of a multimedia player;

FIG. 3B is a illustration of an embodiment of a multimedia player;

FIG. 3C is a illustration of an embodiment of a multimedia player;

FIG. 4 is a illustration of an embodiment of an management module;

FIG. 5A is a illustration of an embodiment of an account management submodule;

FIG. 5B is a illustration of an embodiment of an account management submodule;

FIG. 5C is a illustration of an embodiment of an account management submodule;

FIG. 5D is a illustration of an embodiment of an account management submodule;

FIG. 5E is a illustration of an embodiment of an account management submodule;

FIG. 6A is a illustration of an embodiment of an assets submodule;

FIG. 6B is a illustration of an embodiment of an assets submodule;

FIG. 6C is a illustration of an embodiment of an assets submodule;

FIG. 6D is a illustration of an embodiment of an assets submodule;

FIG. 6E is a illustration of an embodiment of an assets submodule;

FIG. 6F is a illustration of an embodiment of an assets submodule;

FIG. 6G is a illustration of an embodiment of an assets submodule;

FIG. 6H is a illustration of an embodiment of an assets submodule;

FIG. 7A is a illustration of an embodiment of a players submodule;

FIG. 7B is a illustration of an embodiment of a players submodule;

FIG. 7C is a illustration of an embodiment of a players submodule;

FIG. 8A is a illustration of an embodiment of a preview and publish submodule;

FIG. 8B is a illustration of an embodiment of a preview and publish submodule; and

FIG. 8C is a illustration of an embodiment of a preview and publish submodule.

### DETAILED DESCRIPTION

In the following detailed description of embodiments of the invention, reference is made to the accompanying drawings in which like references indicate similar elements, and in which is shown by way of illustration, specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims. As used in the present disclosure, the term “or” shall be understood to be defined as a logical disjunction and shall not indicate an exclusive disjunction unless expressly indicated as such or notated as “xor.”

It is difficult for the average small to medium sized business to create and deploy video on the internet. Usually these entities are limited to just uploading a video onto a web page where it can be viewed as a static file all in one monolithic piece. The system and methods of the present disclosure address this problem by supplying: a web based system for rapidly creating interactive clip based interactive video projects; systems for uploading and deploying the interactive video clips; an efficiency platform to host the streaming of those videos; and an easily packaged HTML code snippet for embedding the video and the interactive player in web sites; and user statistics at the clip level for the videos uploaded.

Moreover, the system and methods of the present disclosure provide a platform whereby multimedia may be viewed non-linearly. Users viewing the multimedia have complete control over what is viewed and in what order, rather than forcing the multimedia to be displayed as one long ordered sequence. Consequently, the user viewing the multimedia has better control of the time needed to experience the multimedia and may view the multimedia in whatever desired sequence and time constraints. Additionally, because the user is not forced to stream non-desired portions of the multimedia, the server bandwidth is saved because the overall multimedia presentation is divided into a plurality of individually viewable clips that may be experienced in a sequential order determined by the user. Thus, to access what would be middle content in a multimedia presentation, the user need not download everything before the desired portion; rather, the user downloads or streams just the middle portions, which reserves the bandwidth that would have otherwise been used for undesired portions of the multimedia presentation.

One of the difficulties with respect to multimedia is parsing together multimedia originating from a plurality of individual video clips. The inventors of the present disclosure discovered that by providing a web based system that manages a plurality of individual multimedia clips, the process is streamlined for users saving time and providing an elegant platform for the presentation of their multimedia.

Accordingly, making interactive videos comprises simply uploading multimedia files and inputting descriptive text and linking URLs using a menu driving, online interface. The interface saves time because the user creates the entire multimedia presentation on a per-clip basis. By creating videos in this way, users upload and assemble each aspect of the project as they go. This flexible, simple, and straight forward paradigm is very much in line with to how people think about video, and is more user friendly. Thus, the devices, systems, and methods of the present disclosure helps users organize their videos in the same was and as an effective natural extension of the creative thought process, which allows the users to organize full multimedia presentations in same way that they would mentally organize the multimedia.

The present disclosure provides devices, systems, and methods that provide the ability of multimedia content owners (users) to organize and display multimedia content. Additionally, viewers of the multimedia are given the ability to view video clips non-linearly as desired, which conserves network bandwidth and server usage, and generally allows users to customize their experience viewing the multimedia depending on their desires and other externalities, such as time constraints.

Users are able to convert multimedia, such as raw video and photo assets into web accessible entities called “players” and to enable collaboration between various people involved with this process at different levels.

Because of the way in which multimedia presentations are created according to embodiments of the present disclosure, the video clips of the multimedia presentation are highly interactive in a seamless way. Viewers are able to see lists of available projects and their sub-clips in the multimedia player interface. Multimedia is streamed as if it were a traditional video segment, but viewers are able to navigate directly to clips of the multimedia presentation directly, without the need to either download or experience the temporally preceding multimedia content. Thus, viewer have a tool anaiconus to a table of contents in a book for multimedia content. Thus, viewers may determine their own temporal sequencing for the clips, omitting clips they do not wish to experience.

As an added feature, text and internet links may be provided as part of the multimedia experience, allowing for informational links to be opened or advertising revenues to be generated as part of each multimedia clip. For example, viewers may click a hyperlink during a clip, which pauses the playing clip, opens up a new window for viewing the link. After viewing the linked page, the viewer unpauses the player and continues viewing the clip. Thus, the present disclosure provides users with a professional and attractive way to weave their multimedia content into websites in a simple and automated manner.

The backend of the devices and systems of the present disclosure automates uploading and creating multimedia presentations. Currently, uploading a video and displaying it on a web page takes the knowledge and skill of a web designer and can be tricky coordinating playback for all viewers across webbrowsing platforms, etc. The present system provides a web based application that guides users through uploading of a file and creating a code that can be inserted into any webpage to embed the multimedia content. Thus, the devices, systems, and methods of the present disclosure allow lay users quickly upload, create, and deploy multimedia content on their websites.

The present disclosure provides platforms for more efficient transmission of multimedia content over the internet. The hosting and playing of internet multimedia occurs primarily in two ways: streaming the video to the user as they watch it and through progressive download. Streaming is somewhat efficient in the use of bandwidth, because only the video that the user is actually watching is sent. However, streaming requires the maintenance of a two-way connection between the player and the server that is expensive on the server side. Moreover, the number of users that each server serves is limited by this ongoing maintained two-way connection. Similarly, with progressive download server overhead associated with streaming is preserved, but bandwidth is wasted in excess data transfer. With progressive download, if the user starts to watch a 30-minute video, for example, and then pauses it, the server will continue to send the entire 30-minutes of video to their player. So, if the user ends up not continuing the video, the bandwidth used for the unwatched portion is wasted.

According to the present disclosure, the multimedia content is broken up into a plurality of simple segments or clips with links and descriptions. Each clip is progressively downloaded to the viewer as they experience it. So, if the viewer pauses the player during a clip, just as with normal progressive download, the whole clip will be sent to their player. However, because each clip is fairly short, usually not much longer than a minute or two (all though they can be any length), the inefficiencies associated with progressive download of the entire multimedia presentation is avoided. For example, sending the viewer an extra minute of video that they may not end up watching is not as significant a loss of transfer bandwidth as if the entire multimedia content is downloaded. Thus, if a 30-minute video is deployed and viewed with our clip based system, the efficiencies would be superior than both the streaming and progressive download methods.

To aid those without the technical resources or savvy in making multimedia content accessible using the devices, systems, and methods of the present disclosure, a simple code snippet is generated after the user uploads their multimedia clips, which can easily be put into a web page, emailed, or distributed in any way via the normal distribution methods of HTML currently utilized on the internet. Distribution by theses methods doesn't add any load to the user's servers, because the multimedia is handled by the servers implementing the devices and systems of the present disclosure, which are optimized for multimedia. Thus, the multimedia content doesn't add any complexity to the users website, because the party implementing the devices, systems, and methods of the present disclosure manages the multimedia.

The systems of the present disclosure may be adapted to keep usage statistics for the multimedia content on a per clip or per multimedia project basis. Thus, users may monitor any number of statistics of viewer behavior with respect to the multimedia content. For example, an internet marketer may use the statistics in combination with their existing web site stats packages to determine exactly which clips caused customer abandonment, purchase, non-action, etc. Use of such data allows them to fine tune the multimedia presentation and related website offerings, for example by altering the ordering of the clips, which is accomplished quickly and easily using the devices, systems, and methods of the present disclosure, to improve their conversion rates, for example.

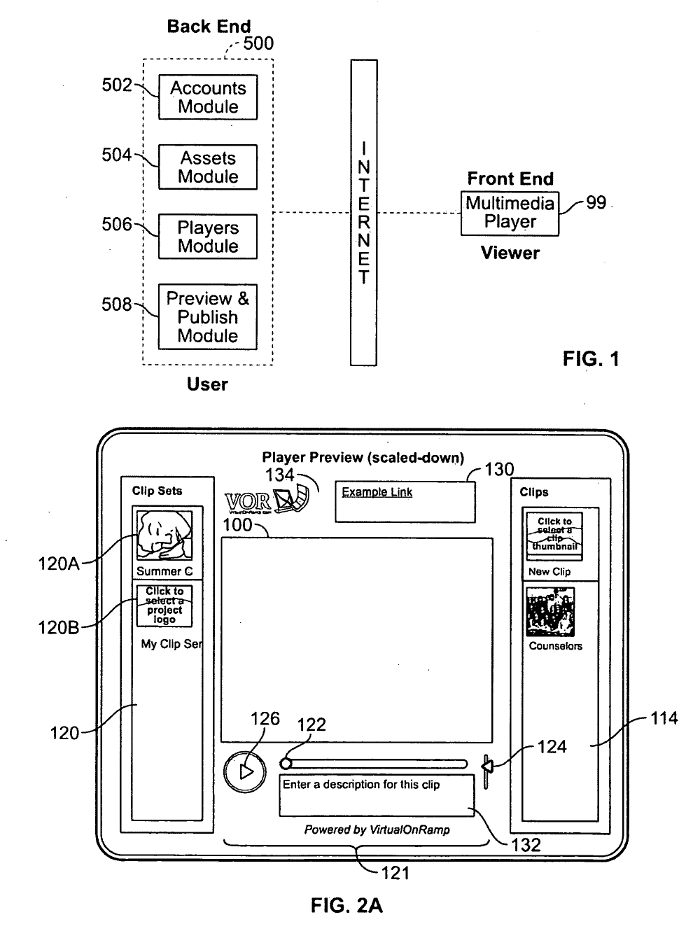

According to embodiments and as illustrated by the block diagram in FIG. 1, the devices, systems, and methods of storing, organizing, and displaying multimedia content according to the present disclosure is shown. Accordingly, users interface with the devices and systems using a project manager, which comprises one or more backend modules designed for uploading, organizing, and creating the multimedia content to be offered to viewers. Viewers experience the multimedia content via the player, which serves as a frontend of the devices and systems of the present disclosure.

More specifically illustrated in FIG. 1 is an exemplary embodiment wherein a user uses project management modules 500 to manage multimedia content that is made available over the internet to player 99, which is available to viewer for viewing the multimedia content. According to embodiments, project management module 500 comprises accounts module 502, assets module 504, players module 506, and preview and publish module 508.

According to embodiments, project management module 500 is broken into areas of management functionality:
Account management
Asset management
Player creation
Player configuration and review
   Each area is presented in its own tabbed pane in an the application. The typical workflow is from left to right starting with Account Management Module 502 to Player Configuration and Review Module 508. Users viewing the player will have the option to view the player and will not be presented with the options outlined above. To put the management features into context, the present disclosure describes the player and then each of the areas of management functionality.

### Player Module

Player 99 allows a viewer to experience multimedia content on the internet from within a browser or other software applications that can display internet and multimedia content. For the purposes of the present disclosure, a player shall be defined as at least one clip set and at least one clip of multimedia content that is perceivable by a viewer.

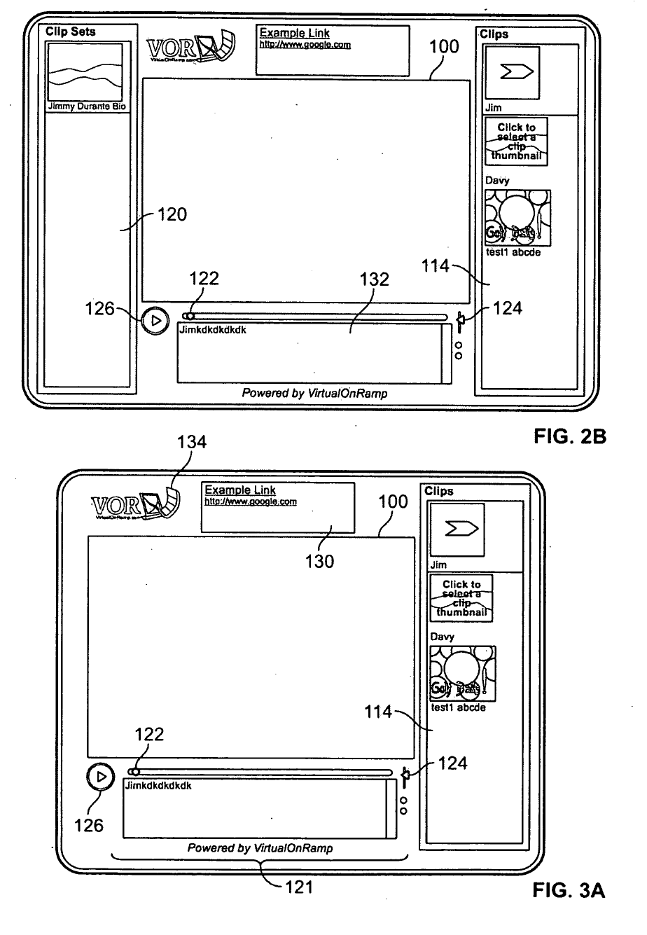

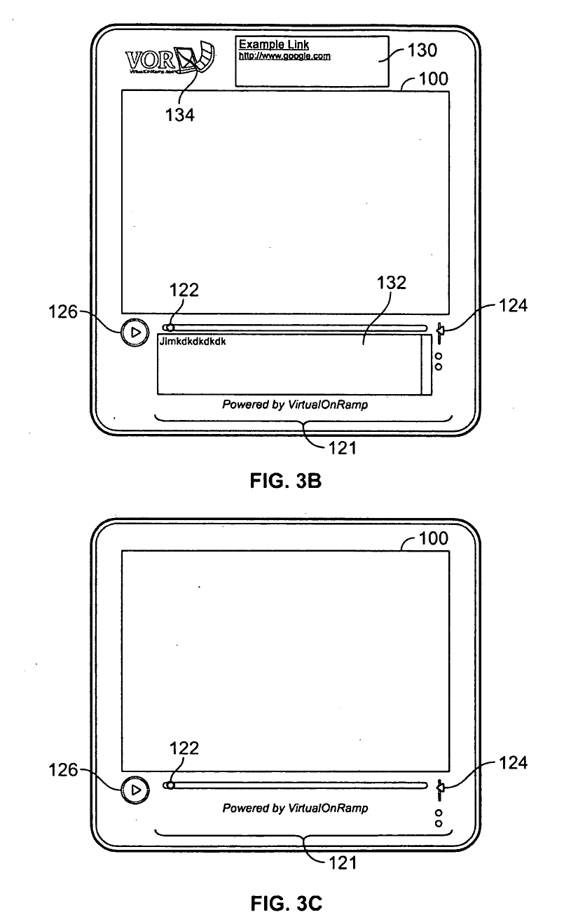

As illustrated in FIGS. 2B-3c, Player 99 comprises several components:
Video Display 100 is a video display that shows pictures and video clips to a viewer;
Clip Set Docking Panel 120 lists all of the clip sets associated with a given player;
Clip Docking Panel 114 lists all of the clips associated with a given clip set, and may be shown iconically or as a textual list;
Scrubber 121, which imparts controls to the viewer experiencing the multimedia;
Video Slider 122 allows the viewer to monitor and manipulate the position of multimedia content such as audio and video that has a component of linearity over time;
Volume 124 allows the viewer to control the volume of the multimedia audio content, if present;
Play/Pause Button 126 allows the viewer to pause multimedia content and resume experiencing the multimedia content;
Link Box 130 shows active links associated with the multimedia clips being experienced;
Text Description Box 132 allows the content owner to text along with the multimedia content; and
Active icon 134, which displays the icon or title of the currently playing multimedia. According to embodiments, Active icon 134 may also show a general title of the player, clip set, clips, or website.

When player 99 first appears on the webpage, multimedia content is loaded from a server and begins playing the first clip of the first Clip Set. Each Clip Set has a icon on Clip Set Docking Panel 120. Clicking on a clip set icon selects that clip set 120A, 120B and causes the player to display its associated clips in the Clip Docking Panel 114. If the viewer selects a clip in Clip Docking Panel 114, the currently playing clip stops and the newly selected one begins playing. If Play/Pause Button 126 is pressed, the video toggles between playing and not playing. When paused, the button displays a blue ‘Play’ triangle. When playing, the button displays a pair of parallel vertical ‘pause’ lines. If the volume slider is moved up, the volume increases in intensity. If it is moved down, the volume decreases in intensity. If a link in Link Box 130 is clicked, the player stops playing and a new browser window opens to the web site specified by this link, according to embodiments. If Active icon 134 is clicked, a new browser window opens to the web site specified by the icon link in the player settings.

According to embodiments, player 99 is configured in a plurality of possible modes. For example, player 99 may be configured to be displayed in one of the following ways:
Full size (as shown in FIGS. 2A and 2B)
Hide Projects, whereby the Clip Set Docking Panel 120 is hidden from the viewer's view (shown in FIG. 3A).
Hide Clips, whereby the Clip Docking Panel 114 is hidden from the viewer's view (shown in FIG. 3B, together with Hide Projects selected). According to embodiments, viewers may be able to see the Clip Set Docking Panel 120, but not the Clip Docking Panel 114.
Hide all, whereby only Video Display 100 and Scrubber 121 is shown to the viewer (shown in FIG. 3C). It should be noted that the Text Description Box 132 and the other components of the player may be optionally shown or not shown, depending on the implementation and options selected by the content owner.

According to embodiments, when configured in a reduced mode (besides full size) the player progresses through projects and clips in order from top to bottom (i.e., in the clip order determined by the user) until done.

It should be noted that, wherever possible, familiar paradigms in graphical user interface design have been followed to minimize confusion and enhance the viewer experience. For example, in several screens there are ‘tree’ controls which are similar in form and function to those seen in common operating systems such as Windows, Mac, Unix, or Linux-based operating systems. These controls use familiar terms and functionality such as ‘folder’ and ‘copy’ as well as drag and drop functionality, etc.

According to embodiments, viewers are able in various degrees, to control the way in which multimedia is presented. For example, the present disclosure may be used to display homes for sale. Each clip set may comprise a single property for sale. For each clip set, the clips may be short video segments for each room in the home. Thus, if a viewer is particularly interested in the kitchen and bathrooms of a home, the viewer may select to view the kitchen and bathrooms first, thereby saving time on viewing the video clips for the rest of a home having an undesirable kitchen or bathrooms.

To navigate to the kitchen or bathrooms in each clip set, the viewer simply selects the icon for the clip in the Clip Docking Panel 114 irrespective of the default order of the clips. Thus, if the bathroom is the last clip and the kitchen is the third clip, the viewer may select to first view the bathroom clip followed by the kitchen clip. If the viewer does not click on any other clip after either the bathroom clip or the kitchen clip ends, the next clip in the default order will play. Thus, a viewer need not wait for the desired rooms to be displayed, but is able to create a customized viewing experience that saves both the viewer time, as well as the server's bandwidth.

During the viewing of any clip, the viewer may be presented with textual descriptions in Text Description Box 132. For example, as the viewer views the kitchen, Text Description Box 132 may highlight the oven and range installed, types of plumbing hardware, and square footage, etc. Moreover, the content owner may include links to the model of the oven and range or plumbing hardware installed or a close-up of the floor plan in Link Box 130. When the viewer clicks on a link, a popup window may be displayed showing linked information.

For the viewer to view a different home, the viewer would simply click on another clip set in Clip Set Docking Panel 120. Like Clip Docking Panel 114, although there is a default order in which the clip sets would be played, the viewer may select the clips set that is desired at any time. To aid the navigation of the viewer, according to embodiments, the currently playing clip set and clip may be highlighted or noticed to the viewer using other visual indicia.

Similarly, the present disclosure would be useful in a sports context. Recently, baseball players, in particular, have collection repositories of video clips of opposing pitcher or hitters to study prior to games. These are often watched via DVD. Use of the present disclosure, however, improves on the prior techniques based on the organizing principle. For example, clips sets of each batter may be prepared for a player. Each clip would comprise a single at bat from the last or current season. Similarly, each clip set could be a baseball game and each clip could comprise a half inning. Clip sets could also be organized by pitcher or batter, and each clip be a games worth of at bats.

### Management Modules

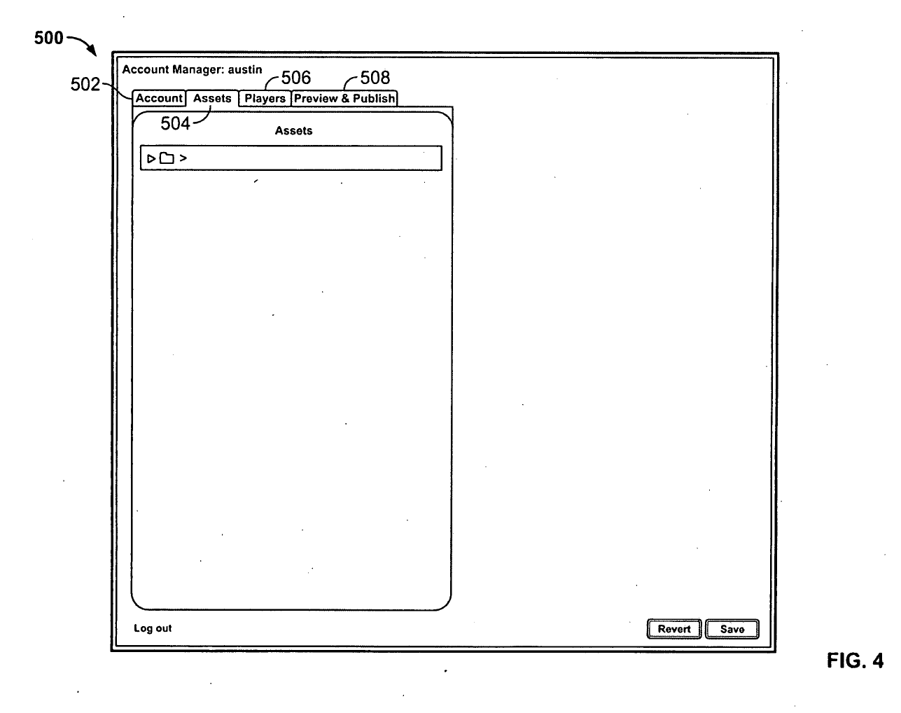

According to embodiments and as illustrated in FIG. 4, clips and clip sets are created by content owners and maintained in Project Management Modules 500. A user maintains account settings in Account Module 502. Clips and clip sets may be uploaded, deleted, and maintained in Assets Module 504 in one or more folders and are used as the building blocks for each player. A clip represents a single multimedia clip and any associated information including a thumbnail photo; any related descriptive text; and zero, one, or more hyperlinks. In Players Module 506, the user copies clips or clip folders (folders containing clips) from the clip set tree created in Assets Module 504. The player tree represents the final content that will be available for viewing on the web. Finally, in Preview & Publish Module 508, the user will be able to preview each player, view its associated deployment code and modify its configuration options. Also, the user can launch a selected player in a web browser to view it as it will appear on web pages to which it is deployed. What follows is a more detailed description of each module.

### Accounts Module

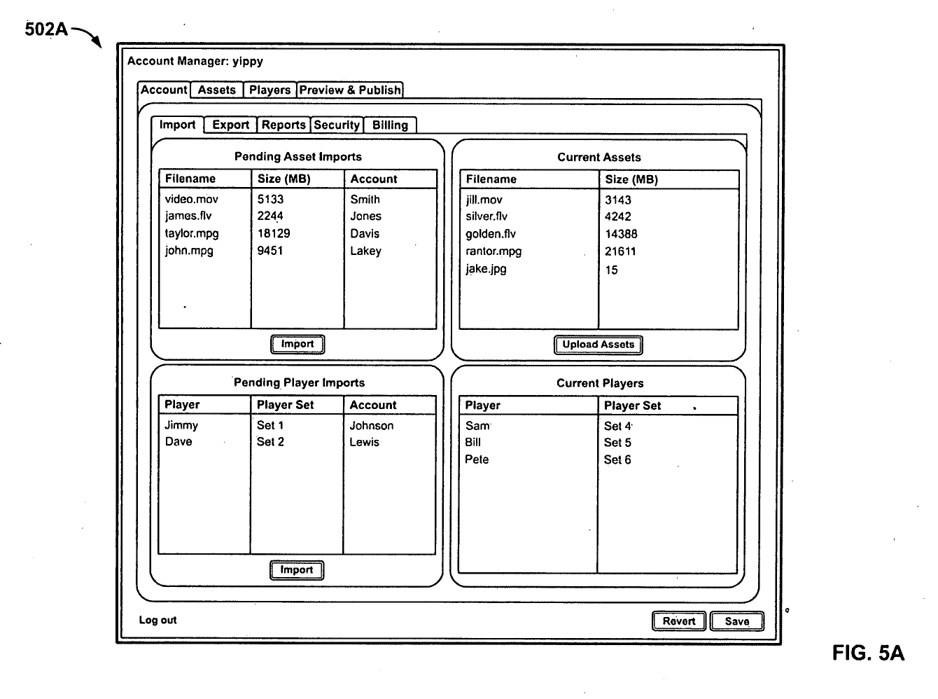

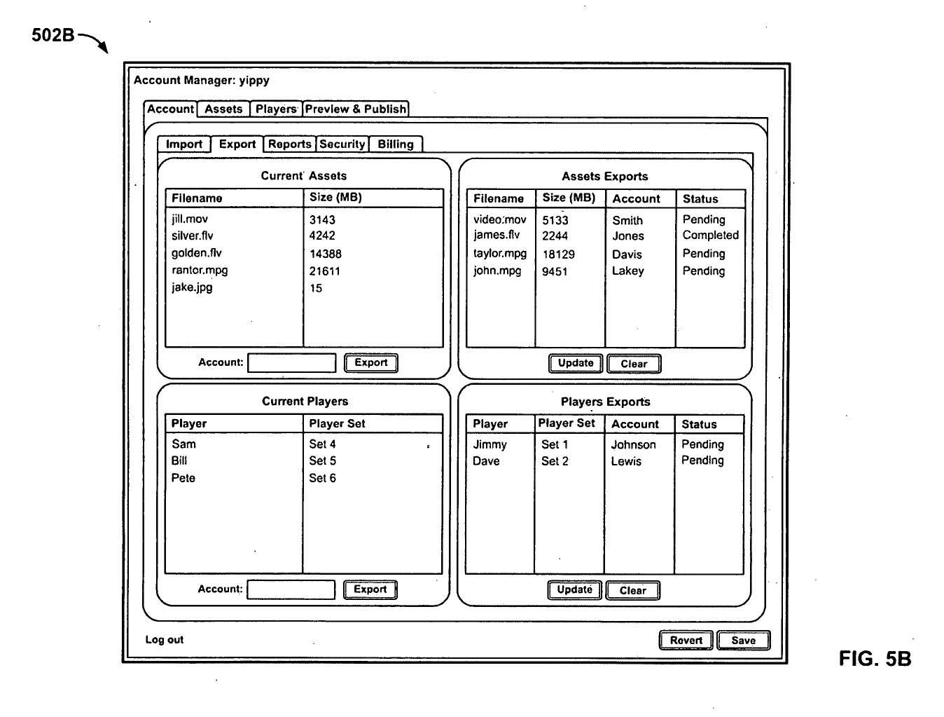

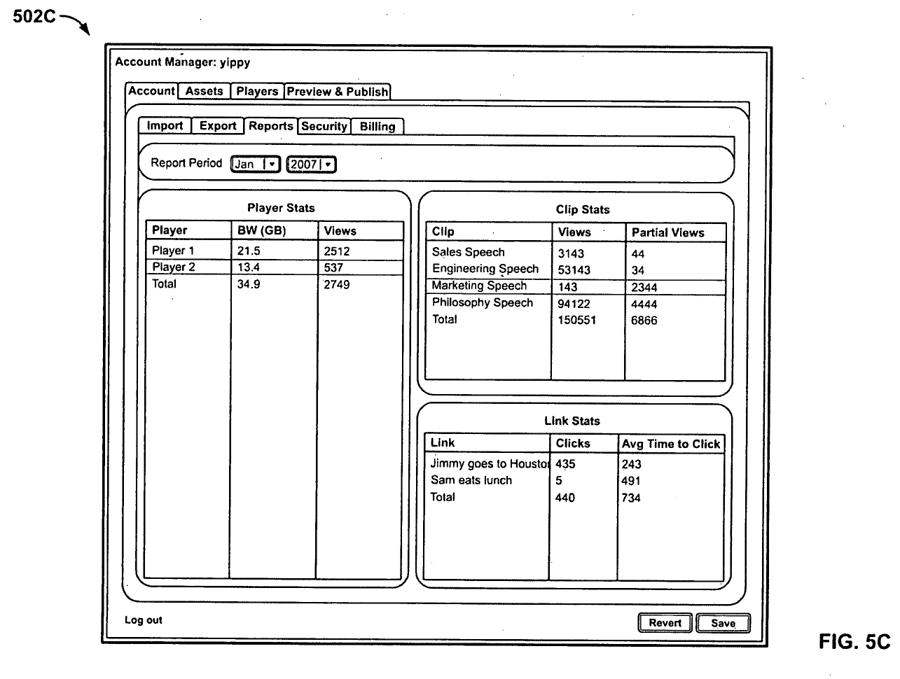

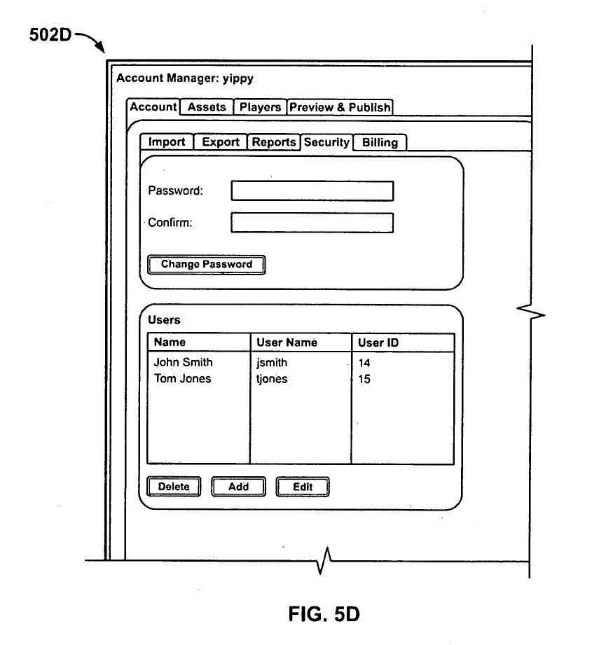

Account module 502 comprises the following sub-tabs for managing a user's account, according to embodiments and as illustrated in FIGS. 5A-5E:
Import
Export
Reports
Security
Billing

According to embodiments, Import tab 502A, as illustrated in FIG. 5A, allows the user to see all assets and players that have been exported to their account from another account. To physically receive these items into the account, they must be selected and the ‘Import’ button must be clicked. When this is done, the selected items are cleared from the corresponding ‘Pending Imports’ list (in either the Pending Assets or Pending Players import list) and are added to the account's own assets list or players list.

The ‘Current Assets’ list also allows the user to upload assets to the account by clicking on the ‘Upload Assets’ button just below the list. This allows assets to be uploaded from the user's local computer.

According to embodiments, Export tab 502B illustrated in FIG. 5B allows users to transfer or copy players or assets to other accounts. In order to begin this process, the user selects one or more items (either players or assets), enters the name of the receiving account and clicks the ‘Export’ button.

Exporting an asset places a copy of the asset onto the corresponding ‘Exports’ list with an initial status of ‘pending’. The status field indicates whether the receiving account has ‘imported’ the asset. To refresh the status column values, the ‘Update’ button must be clicked. To clear assets from the ‘Exports List,’ they must be selected and then the ‘Clear’ button must be clicked.

According to embodiments, Reports tab 502C illustrated in FIG. 5C allows users to ascertain the overall usage patterns and, to some extent, the effectiveness of their players. The ‘Report Period’ must be selected to determine which month/year is to be viewed. Then, to see more detailed information from a particular player's statistics, that player must be selected in the ‘Player Stats’ list. When selected, that player's clip statistics (Clip Stats) are displayed on the top right panel. If a particular clip is selected from this panel, its link statistics (Link Stats) are displayed in the bottom right panel.

According to embodiments, player stats include the player name, its total bandwidth usage, in bandwidth usage for that month in the ‘BW (GB)’ column, and the number of times the player was activated, in the ‘Views’ column. Clip stats include the ‘Clip Name’, its total ‘Views’ and the number of ‘Partial Views,’ according to embodiments.

According to embodiments, link stats include the link name (the text associated with the link's URL in the text box), the total number of clicks on this link and the average time in seconds it took for a user to click that link from the time the clip started.

According to embodiments, Security tab 502D illustrated in FIG. 5D allows users to change their password and to manage users in their account. To change a password, the user simply enters the new password twice and clicks the ‘Change Password’ button, as is well known and understood by artisans.

To manage other account users, if this user has ‘Admin’ privileges, that user can add, delete, or edit users to/from/in the ‘Content owners’ list by clicking on the ‘Add’, ‘Delete,’ and ‘Edit’ buttons respectively. These buttons activate the appropriate informational or confirmation dialog for the action intended.

According to embodiments, Billing tab 502E illustrated in FIG. 5E allows the user to see their historical billing information. Each month, a record is added to this table containing the following information:
Base amount being billed.
Any additional Bandwidth being charged to the account if usage exceeds the account limits.
Any additional Storage being charged to the account if usage exceeds the account limits.
Total amount billed.

### Assets Module

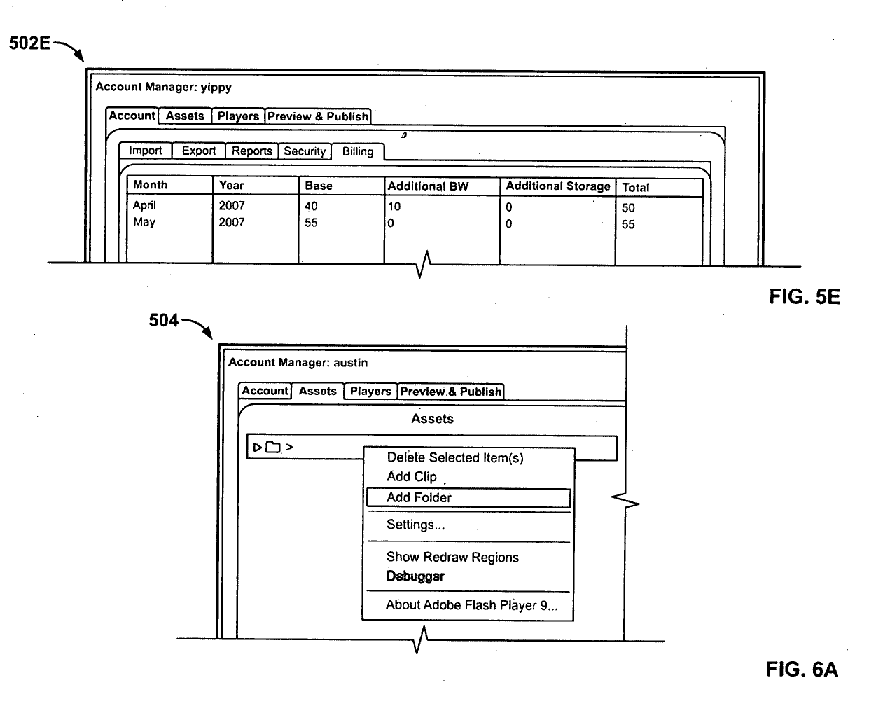

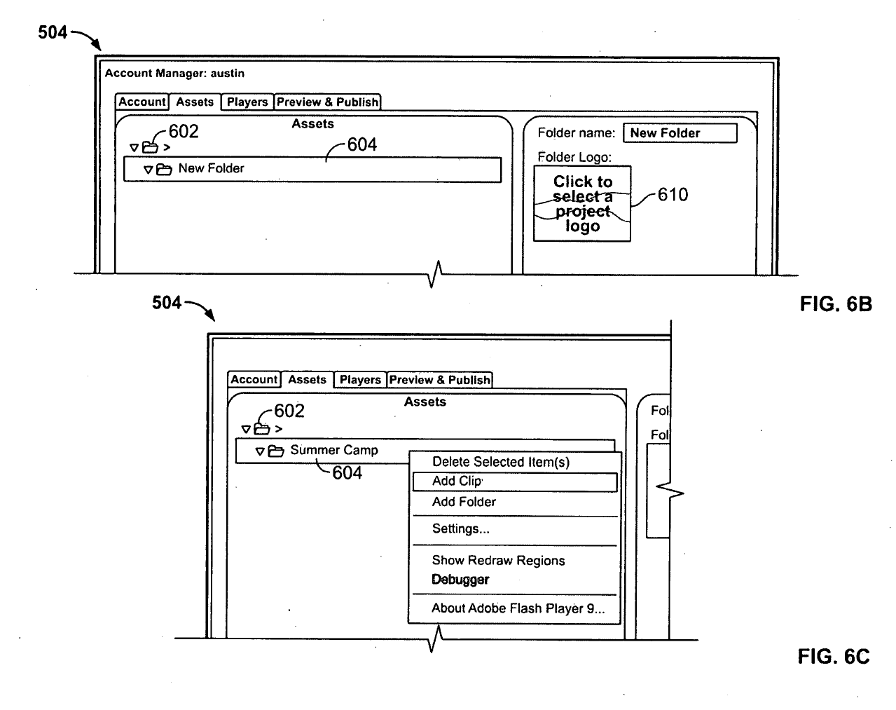

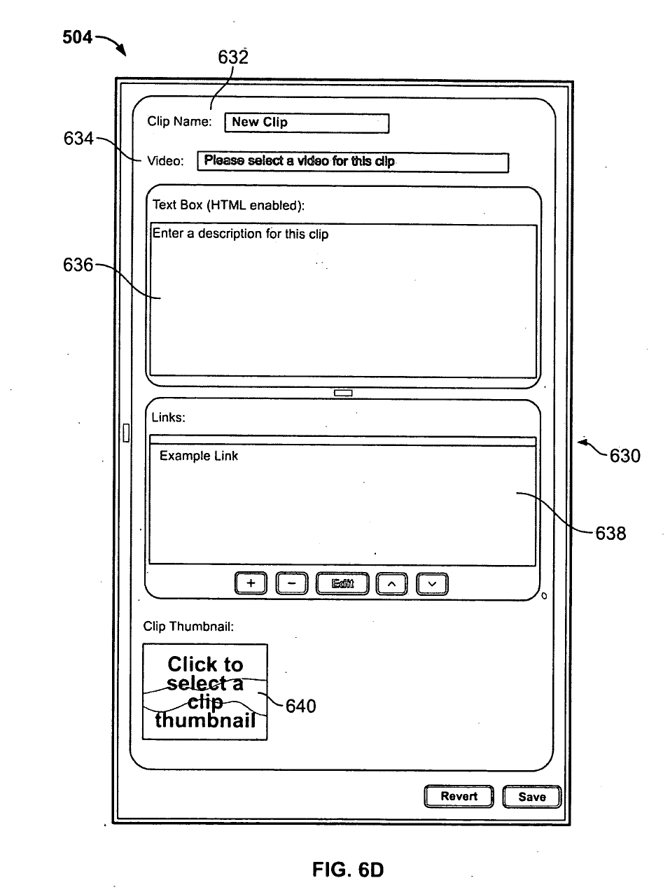

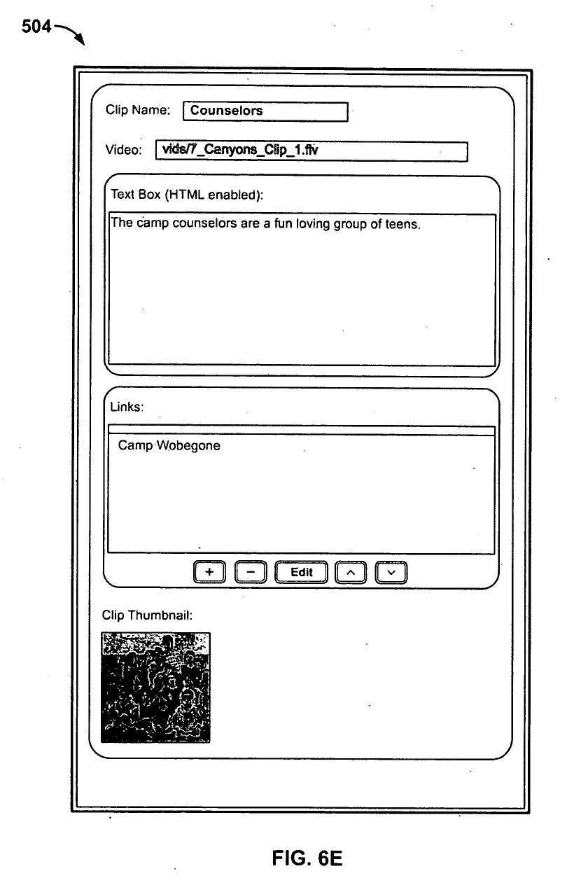

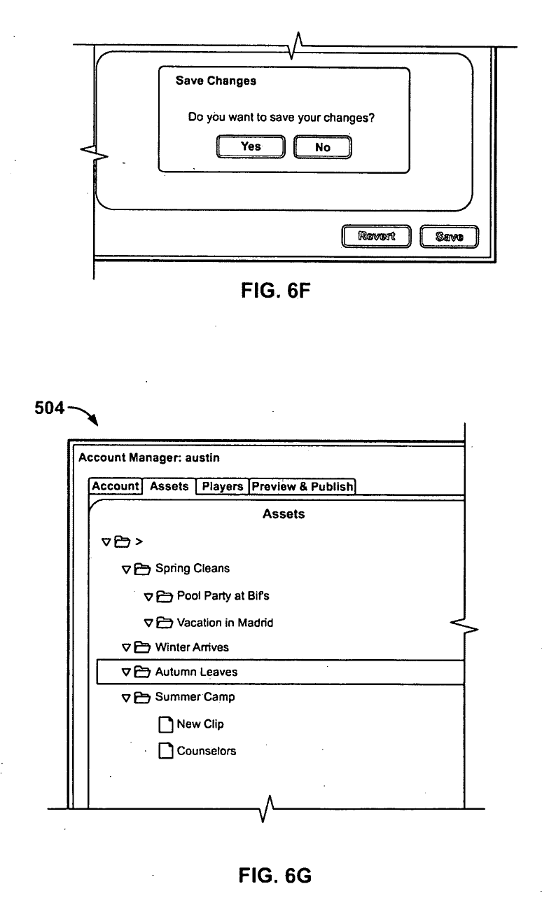

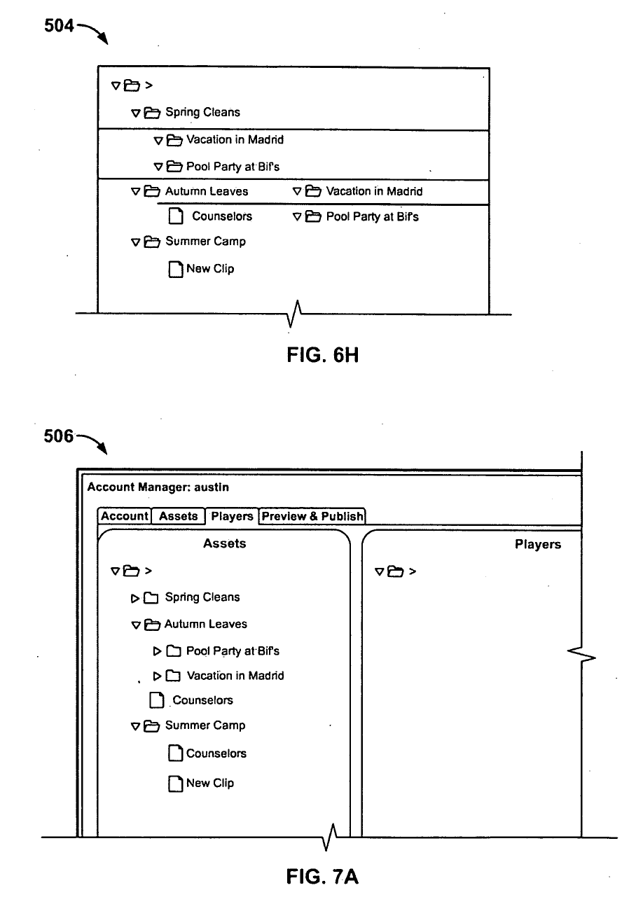

A user begins by selecting the assets module, as illustrated in FIG. 6. This page, upon the first visit, reveals single empty ‘folder’ icon 602 in the upper left corner. This represents the root of the assets tree for the account. Clicking on this icon ‘selects’ it. By right-clicking the mouse on this folder and selecting ‘Add Folder’, a new folder 604 is created as a sub-folder of the root. This folder contains an example icon 610 that says ‘Click to select a project icon.’ Both the icon image and the folder name may be changed. To change the folder name, the user clicks in the ‘Folder name’ “input text field” and enters a new name.

The icon for this folder will appear in the Player as a ‘Clip Set,’ which represents a set of clips that can be viewed. By clicking on image placement icon 610, the user can change the icon file to an image file from their local disk drive that will be displayed in the player.

By selecting an image file, example icon image 610 is replaced by the selected image. If this image is large, a progress monitor will appear showing the percentage of the file transfer that is complete. The image is uploaded whereby the server copies the image file from the user's computer.

Folder 604 created is used to hold one or more ‘Clips.’ To create a clip, the user right clicks on folder 604 and selects the ‘Add Clip’ menu item, as illustrated in FIG. 6C. It should be noted that the GUI mimics operating system functionality whereby the user may right click on various items to have a popup menu shown. Selecting new clip creates a clip in the clip set and clip editor 630 (FIG. 6D) is presented. This editor reveals the new clip's attributes which have example values filled in, as shown in FIG. 6D. These attributes can are editable and form the content shown in the player as each clip is experienced.

According to embodiments, each clip may have the following attributes:
Clip Name 632
Multimedia, shown as video 634
Text Box 636
Links 638
Thumbnail 640
   By selecting each of these attributes, the user can change them.

According to embodiments, Clip Name 632 is changed by selecting Clip Name 632 field and entering a new name in the same way that the folder name was changed. The multimedia, such as a video, is uploaded in a similar to the way that the folder icon was changed by using the video field. By clicking on this field, the video upload dialog appears and the multimedia can be uploaded.

If this file is large, the progress window appears. Once uploaded, the filename for this video appears in the clip editor in this field. The text box is another attribute that can be edited similar to the way that the clip name and folder name fields were edited.

According to embodiments, Links Attributes 638 represents one or more hypertext links that will be presented alongside the player video screen. These links are created and maintained by editing them here. By clicking on the link called ‘Example Link’ and pressing the ‘Edit’ button, the Link Editor dialog appears, which allows the user to change the URL and descriptive text for this link. Once modified, the new Link Text appears in the Links list. The URL appears as a tool tip which is visible as the mouse cursor passes over the text in the list, according to an embodiment. To add links to this list, the user can click on the ‘+’ button or hit the ‘insert’ key on their keyboard. To delete links, the user can select the link(s) to be removed, then click on the ‘−’ button or hit the delete key on their keyboard. Links can be re-ordered by selecting one and then clicking on the ‘up’ or ‘down’ arrow button to move that link up or down in the list respectively. This can also be accomplished by holding down the ‘Control’ key and simultaneously pressing the ‘up’ or ‘down’ arrow key on the keyboard.

According to embodiments, Clip thumbnail 640 is alas modifiable. This image can appear in the player as a selectable icon that plays the associated multimedia file. In this case, clicking on the icon will play the multimedia file with which it is associated. To modify the thumbnail, the example thumbnail is clicked in the Clip Editor and the same steps outlined above for the folder icon thumbnail are followed. FIG. 6E illustrates a clip editor wherein each attribute is populated.

According to embodiments, each project is saved in order to have the changes recorded by the server. To do this, the user clicks on the ‘Save’ button in the lower right. This reveals the ‘Save Confirmation Dialog,’ as shown in FIG. 6F. The user clicks ‘Yes’ and continues to save. If the user chooses not to save the changes, for whatever reason, the user clicks ‘No.’

After a clip is created, the user may create additional clips for each folder. Naturally, the user may also delete clips from the folder in the same way. Thus, the present disclosure provides a platform for easily adding and removing clips to an overall multimedia presentation without the need to redo the entire presentation. Also, other folders may be created at various levels of nesting to help organize assets, as illustrated in FIG. 6G.

By right-clicking on a folder, at any level, and selecting the ‘Add Folder’ menu item, a new folder is created. As the example above shows, any level of nesting can be created. Three levels are illustrated in FIG. 6G: a root level folder, a two levels of clip folders. The functionality, according to embodiments, mimics that of the disk file systems used in popular operating systems. To expand or collapse a folder, the user clicks on the arrow icon to the left of the folder label.

To delete an item in the tree, one selects it and either hits the ‘delete’ key on the keyboard or right-clicks the mouse and selects the ‘Delete Selected Item(s)’ menu item. If one deletes a folder, that folder and all its contents, including sub-folders and clips, are deleted. A confirmation dialog will require the user to confirm this decision. In some cases, deleting a clip or folder from the Assets tree can effect the Players tree.

According to embodiments, to move a folder or clip in the tree, one selects it and then drags and drops it to its desired new location, as illustrated in FIG. 6H. This operation includes visual clues to aid the user in accurately dropping the selected item. To move multiple items, similarly, one selects them and drags them to their desired new location. They will appear in the order they were selected, so if two items were selected, the bottom item first, the bottom item will appear above the other one at the drop location, for example.

To copy folders or clips, one holds down either ‘Ctrl’ key on the keyboard and drags the selected item(s) into the desired new location as done for a move. This creates a copy of the item at the new location. The original item remains where it was.

### Players Module

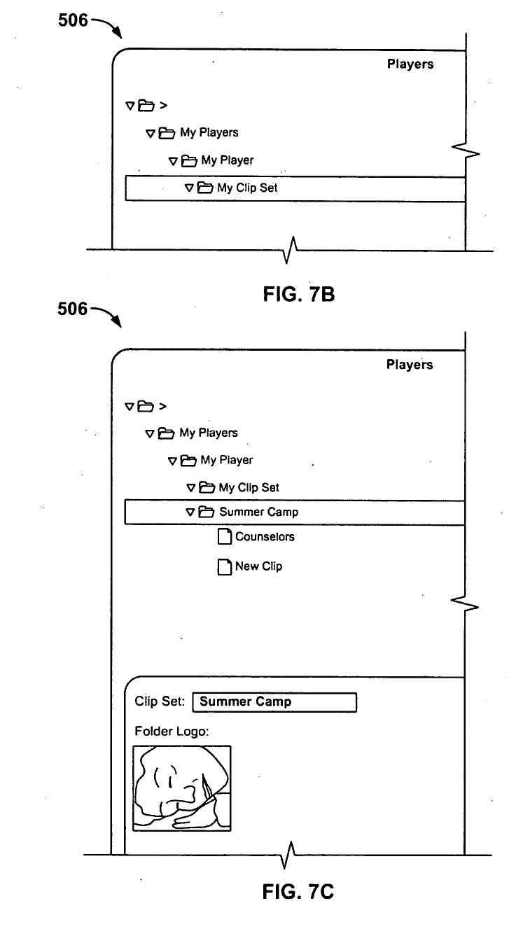

Players module 506 is a natural extension of Asset module 504, which is where the clip sets are created, each having at least one clip. Once assets have been created in the Assets module, they can be used to create players in Player module 506, as illustrated in FIG. 7A.

The user selects the ‘Players’ tab. On this page there are two ‘Tree’ controls, each with similar characteristics. The Assets tree, on the left, is a read-only representation of the tree in the Assets tab. The Players tree, on the right, represents a new organizing structure for use in assembling ‘players’ for web deployment.

According to embodiments, the Players tree hierarchy is more strictly constrained than the Assets tree. At the top of the Players tree is the root, similar to the Assets tree root. This can have many sub-folders of a type called a ‘Player Set.’ Within Player Set folders there can be one or more ‘Player’ folders. Within each Player folder, there can be one or more ‘Clip Set’ folders. A Clip Set is a folder containing one or more clips. FIG. 7B shows an exemplary organization according to this organizing principle.

To start, a user will create a Player Set by selecting the root icon and either using the ‘Add Folder’ context menu or by hitting the ‘insert’ key. The new Player Set name can be changed now by entering the new name in the Player Set text input field below.

Similarly, a new Player is created by selecting the new Player Set icon and either using the ‘Add Folder’ context menu or by hitting the ‘insert’ key. Thereafter, the user adds Clip Folders from the Assets tree or creates a new Clip Set (shown in FIG. 7B as “My Clip Set”). To create a new Clip Set, the user follows the same steps used to create the Player, that is press the ‘insert’ key or select ‘Add Folder’ from the context menu.

According to embodiments, a usable Player must contain at least one Clip Set and one Clip. To continue, the user can now copy a Clip Set from the Assets tree on the left by dragging it and dropping it into a Player in the Players tree on the right. In this example, we have a Player called ‘My Player’ with two Clip Sets: ‘My Clip Sets’ and ‘Summer Camp,’ as shown in FIG. 7C. When an item is selected in either tree, a summary of that item appears below the tree, as illustrated in the bottom portion of FIG. 7C.

### Preview and Publish Module

After the Clips Sets and clips are added to each player as desired, the players can be deployed to the web. Deployment is accomplished in ‘Preview & Publish’ module 508. According to embodiments, Preview & Publish module 508 contains four components:
Players Tree 802
Previewer 804
Deployment Code Viewer 806
Player/Player Set Options Editor 808

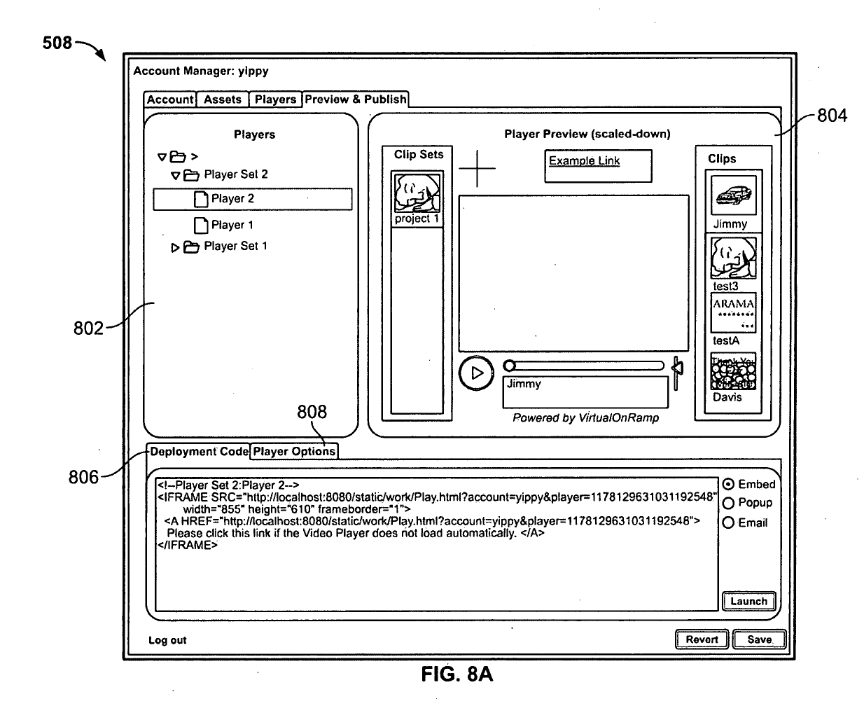

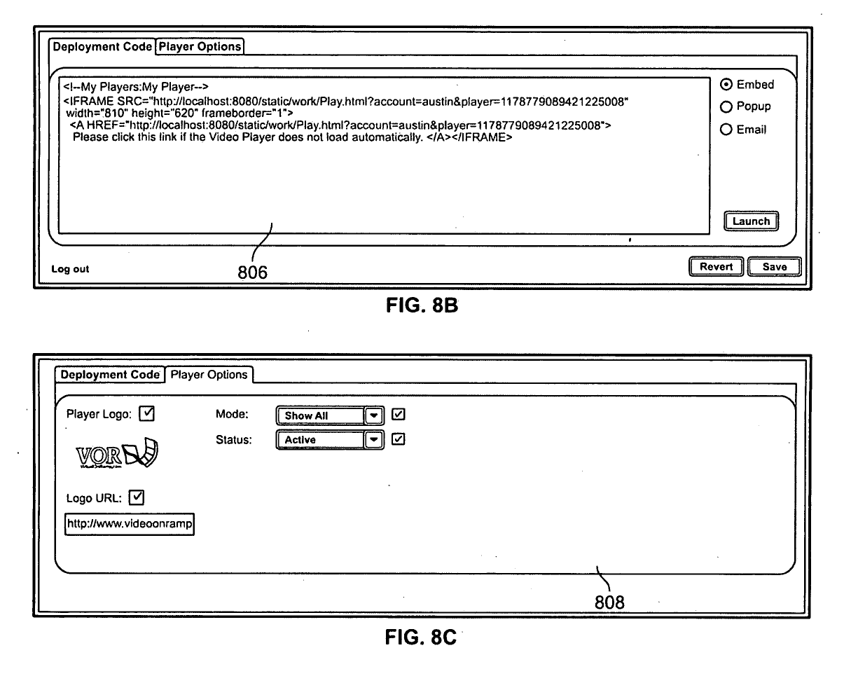

According to embodiments and as illustrated in FIG. 8A, at the top left of the Preview/Publish page is Players tree 802. This is a read-only view of the Players tree from the Players tab where nothing is visible below the Player nesting level. Since the player is our primary focus on this page, we don't need to see the player contents in the tree view, according to embodiments. Rather, the contents in player previewer 804 is the location where clip sets are able to be viewed, shown in the top right of FIG. 8A. Player previewer 804 shows a scaled-down working version of the player that was selected. If no player is selected, player previewer 804 is hidden. When a player is selected, player previewer 804 is loaded with that Player's Clip Sets and corresponding Clips, ready for viewing.

At the bottom of this page, according to embodiments, is a tabbed pane containing the other two components: Deployment Code Viewer 806 and Player/Player Set Options Editor 808.

At the root of Players tree 802 are one or more ‘global defaults’ for player options 808, as illustrated in FIG. 8C. Each Player Set inherits the values for these options from these global values. If a Player Set option is explicitly set, then that value overrides the global value for all Players in that set. To override a default value for an option, the checkbox next to the option is uncheck, allowing for editing of that option. At the Player options level, values for each option are shown. If a default box is checked, that value is inherited from the Player Set in which that Player is located. If a Player is moved to another Player Set where a given option has a different value, the Player inherits that different value for the given option and any other options set to default, according to embodiments.

Deployment Code Viewer 806 as illustrated in FIG. 8B, when selected, shows the deployment code associated with all selected Players in the tree. Deployment code is the actual HTML code that, when inserted into a web page or email, causes the Player or a link to it to be rendered and activated. If more than one player is selected, or if one or more Player Sets are selected, the deployment codes for all associated players are shown in the text box in Deployment Code Viewer 806. On the right of the Deployment Code Viewer 806 selectors are disposed for choosing which type of deployment code to view. According to embodiments, these may be:
Embed
Popup
Email

The Embed code, when inserted into a web page, creates an Iframe which invokes the player within a fixed size box on the page. According to embodiments, uniform resource indicators may point locally (as shown by the code in FIG. 8B pointing to ‘localhost’) or relative to the internet. The Popup code creates a link which, when clicked, pops up a player in a separate window. The Email code is a link that, when inserted into an email, can be clicked and also bring up a Popup player.

A launch button will be active when a player is selected in the tree. If clicked, it will create a popup browser window to display the contents of Deployment Code Viewer 806 in a web page, thus allowing the user to see the exact effects of any changes to the player content or options. This shows the player in a context that is as close to the final deployment as possible, for preview purposes.

According to embodiments, when clips are copied from the Assets tree to the publish tree, links are created which point back to the original clip to preserve storage space. One benefit of this design is that it allows changes to be made in the Assets tab, after player has been deployed to the web, and change Clip attributes like thumbnail or even video content without having to repeat the process of copying the Clip back to the player. Instead, after changes are made, the Save button is pressed and the players are automatically updated to reflect any changes. This means that Clips cannot be deleted from the Assets tab page without affecting the Players in which these clips are used. If a ‘linked’ clip from the Assets tab is deleted, additional information is presented prior to deletion in the Delete Confirmation dialog warning of the side effect to the deployed player.

The following options tree may be implemented, according to embodiments:

icon
icon url
player mode:

all
hideProjects
hideBoth
hideAll

status:

active
preview

password:
icon size
‘advanced’:

video mode:

force size
run as is (default)

video size (height, preserve aspect): default=336
link box enable/height: default=enable/76
description enable/height: default=enable/70
left/right panel enable/height: default=enable/585
thumb/icon height: small,med,lg: (50,75,100): default=med

translates to proper panel width.

The process described above can be stored in a memory of a computer system as a set of instructions to be executed. In addition, the instructions to perform the processes described above could alternatively be stored on other forms of machine-readable media, including magnetic and optical disks. For example the processes described could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A system comprising:
at least one player having a multimedia presentation;
at least one clip set associated with the multimedia presentation; and
at least one multimedia clip associated with each clip set;
wherein a viewer may experience the multimedia clips in a non-default ordering.

2. The system of claim 1, wherein the clips are video and audio clips.

3. The system of claim 1, wherein the clips are audio clips.

4. The system of claim 1, wherein the clips are presentation slides.

5. The system of claim 1, wherein the clips are at least one of the group consisting of: video, audio, and presentation slides.

6. The system of claim 1, wherein upon selection of a clip, the clips previously being experienced in substantially immediately stopped and the clip selected is experienced.

7. The system of claim 6, wherein each clip has a set of the internet hyperlinks associated with it, and the set of internet hyperlinks is experienced when the clip is experienced.

8. The system of claims 6, wherein each clip has a text portion associated with it, wherein the text associated with each clip is displayed when the clip is experienced.

9. A method comprising:
providing a multimedia presentation backend, wherein a user can upload and organize a plurality of clips into clips sets and players;
wherein each clip may have associated with it hyperlinks, text, images, or other audiovisual supplemental media associated with the clip;
providing a player that:
provides an interface for a viewer to select a desired player comprising at least one clip set effecting the display of the clips associated with the at least one clip set in a default order;
allows the viewer to select desired clips to be experienced from those displayed in an order different from the default order; and
displays at least one of the hyperlinks, text, images, or other audiovisual supplemental media associated with the clip.

10. The method of claim 9, wherein the clips are at least one of the group consisting of: video, audio, and presentation slides.

11. The method of claim 9, wherein upon selection of a clip, the clips previously being experienced in substantially immediately stopped and the clip selected is experienced.

12. The method of claim 9, wherein if a hyperlink is selected the player is paused and a display of the linked information is initiated.

13. A machine readable medium having instructions stored thereon for performing the steps of:
providing a multimedia presentation backend, wherein a user can upload and organize a plurality of clips into clips sets and players;
wherein each clip may have associated with it hyperlinks, text, images, or other audiovisual supplemental media associated with the clip;
providing a player that:
provides an interface for a viewer to select a desired player comprising at least one clip set effecting the display of the clips associated with the at least one clip set in a default order;
allows the viewer to select desired clips to be experienced from those displayed in an order different from the default order; and
displays at least one of the hyperlinks, text, images, or other audiovisual supplemental media associated with the clip.

14. The method of claim 13, wherein the clips are at least one of the group consisting of: video, audio, and presentation slides.

15. The method of claim 13, wherein upon selection of a clip, the clips previously being experienced in substantially immediately stopped and the clip selected is experienced.

16. The method of claim 13, wherein if a hyperlink is selected the player is paused and a display of the linked information is initiated.
